(19) United States
(12) Patent Application Publication
(10) Pub. No.: US 2025/0086434 A1
(43) Pub. Date: Mar. 13, 2025

(54) ARTIFICIAL INTELLIGENCE FOR EVALUATING ATTRIBUTES OVER MULTIPLE ITERATIONS

(71) Applicant: Google LLC, Mountain View, CA (US)

(72) Inventors: Dorothea Wiesmann Rothuizen, Oberrieden (CH); Vincent Leroy, Adliswil (CH); Sai Meher Karthik Duddu, Mountain View, CA (US); Raphael Dominik Hoffmann, Las Altos, CA (US); Dan Beat Kluser, Cham (CH); Iftekhar Naim, Los Gatos, CA (US)

(21) Appl. No.: 18/824,530

(22) Filed: Sep. 4, 2024

Related U.S. Application Data
(60) Provisional application No. 63/581,202, filed on Sep. 7, 2023.

(51) Int. Cl. G06N 3/0455

(52) U.S. Cl. CPC G06N 3/0455

(57) ABSTRACT

Methods, systems, and apparatus, including computer programs encoded on a computer storage medium, for enabling artificial intelligence (AI) to evaluate attributes of items and use the results of the evaluation to provide relevant content. In one aspect, a method includes receiving, by an AI system and from a client device of a user, a first query of a user session. For each additional query, the AI system generates input data based on the additional query and data related to one or more previous queries received during the user session. The AI system provides the input data as an input to a machine learning model trained to output attributes of items and importance data indicating a relative importance of the attributes based on received inputs. The AI system selects one or more digital components based on the set of attributes and the importance data output by the model.

### CROSS-REFERENCE TO RELATED APPLICATIONS

This application claims the benefit under 35 U.S.C. § 119(e) of U.S. Patent Application No. 63/581,202, entitled “ARTIFICIAL INTELLIGENCE FOR EVALUATING ATTRIBUTES OVER MULTIPLE ITERATIONS,” filed on Sep. 7, 2023. The foregoing application is incorporated herein by reference in its entirety for all purposes.

### BACKGROUND

This specification relates to data processing, artificial intelligence, and identifying and evaluating the importance of attributes.

Advances in machine learning are enabling artificial intelligence to be implemented in more applications. For example, large language models have been implemented to allow for a conversational interaction with computers using natural language rather than a restricted set of prompts. This allows for a more natural interaction with the computer.

### SUMMARY

In general, one innovative aspect of the subject matter described in this specification can be embodied in methods that include the actions of receiving, by an artificial intelligence system and from a client device of a user, a first query of a user session; receiving, by the artificial intelligence system, one or more additional queries during the user session; for each additional query: generating, by the artificial intelligence system, input data based on (i) the additional query and (ii) data related to one or more previous queries received during the user session; providing, by the artificial intelligence system, the input data as an input to a machine learning model trained to output attributes of items and importance data indicating a relative importance of the attributes based on received inputs; receiving, by the artificial intelligence system, a set of attributes and importance data for the set of attributes as an output of the machine learning model; selecting, by the artificial intelligence system and based on the set of attributes and the importance data for the set of attributes, one or more digital components; and providing, by the artificial intelligence system, the digital component to the client device for display to the user. Other implementations of this aspect include corresponding apparatus, systems, and computer programs, configured to perform the aspects of the methods, encoded on computer storage devices. These and other embodiments can each optionally include one or more of the following features. In some aspects, the user session comprises a conversation with an artificial intelligence agent and each query includes a prompt for the artificial intelligence agent.

In some aspects, the input data for at least one additional query includes data from one or more previous sessions of the user. In some aspects, the importance data for each set of attributes indicates, for each individual attribute, whether the individual attribute is a required attribute or a user preference.

In some aspects, selecting the one or more digital components includes identifying a set of candidate digital components; identifying, from among the set of candidate digital components, a subset of the candidate digital components having distribution parameters that match each required attribute; and selecting the one or more digital components from the subset of the candidate digital components.

Some aspects include filtering, from the set of candidate digital components, each candidate digital component having a distribution parameter that indicates that the candidate digital component is not eligible for presentation for component requests that include at least one required attribute in the importance data for the set of attributes.

In some aspects, selecting the one or more digital components includes providing the set of attributes, the importance data for the set of attributes, and distribution parameters to an additional machine learning model trained to output values for digital components based on input data provided to the additional machine learning model; and selecting the one or more digital components from a set of candidate digital components based on values for the candidate digital components output by the additional machine learning model.

In some aspects, the input data includes, for each of the one or more previous queries, timing data indicating when the previous query was received during the user session.

In some aspects, the input data includes contextual information extracted from the one or more previous queries.

Some aspects include providing the set of attributes and an additional set of attributes for the digital component an input to an additional machine learning model trained to determine whether attributes for a digital component satisfy an input set of attributes; receiving, from the additional machine learning model, data indicating one or more attributes for the digital component that satisfy at least one of the set of attributes; and adjusting a visual characteristic of text for each of the one or more attributes in the digital component provided to the client device for display to the user.

Particular embodiments of the subject matter described in this specification can be implemented so as to realize one or more of the following advantages. The techniques described in this document use artificial intelligence to evaluate attributes of items (e.g., products or services for which a user submits queries) and to distribute content based on the evaluation. Using the described techniques, the system can more accurately determine the intent of users providing the queries and provide more relevant content quicker (e.g., based on fewer queries), thereby reducing the number of queries processed by the system, the number of responses generated by the system, and the amount of content provided with the responses. This reduces the processing burden (e.g., processor cycles) placed on the system, the amount of bandwidth consumed in receiving and responding to queries, and the amount of memory required to store the queries and content sent in response to the queries. Aggregated over many users (e.g., thousands or millions), the processing and bandwidth savings are substantial. This also reduces the amount of time that a user interacts with their device to obtain relevant content, which saves battery power in mobile devices, e.g., by reducing the amount of time that a display has to be active and illuminated.

The techniques described in this document can use artificial intelligence to determine and update the importance of attributes during a sequence of queries (e.g., a conversation with an AI agent) based on the queries. Using artificial intelligence in this way enables the system to leverage information of multiple queries and the relative timing of the queries (e.g., their position in the sequence) to more accurately determine the importance of the attributes to the user submitting the queries, which enables the system to provide more relevant content at an earlier point in the sequence than other techniques.

In some search systems, the data that the user is seeking may be consolidated in limited ways, typically to just the current user query or a sequence of queries, without considering attributes of items that may be the subject of the query or queries. Using the artificial intelligence techniques described in this document, a language model can be trained to fine tune the importance of attributes over several iterations with the search system, including over multiple user sessions. The described techniques advantageously use the capacity of a language model to infer useful information from selected attributes related to the queries. This enables an artificial intelligence (AI) system to more accurately determine the attributes that are most important to the user and select the most relevant content for the user.

The AI system can summarize, during a user session with an AI agent, the user's intent with required attributes (e.g., hard constraints) and user preference attributes (e.g., user preference attributes) and determine whether a digital component satisfies at least the required attributes based on the queries submitted by the user and contextual information related to the user session, e.g., linguistic clues in the query phrases and when the phrases are provided by the user during the user session. This enables the AI system to accurately identify digital components that satisfy all of the required attributes and filter out those that do not. The AI system can then select one or more digital components that remain after the filtering, e.g., based on their match to the user preference attributes and/or other data. This enables the AI system to select the most relevant digital components for the user without providing irrelevant content that will be ignored by the user and which will waste resources and network bandwidth to present the irrelevant digital components to the user.

For example, consider an initial query “what is the best charcoal grill.” The AI system can determine that charcoal grill, or at least grill, is a required attribute since that is the item for which the user is searching. The AI system can also determine that the user wants a highly rated grill based on the word “best,” and may consider this another required attribute since it appears in the first query about the item of interest. If the AI system provides digital components or other response with some charcoal grills, the user may response “those are too ugly.” Now, the AI system can determine that the user wants a grill that has good aesthetics. A follow up query with “show me more stylish” further indicates that the user wants a stylish grill, and the AI system can consider “stylish” to be another required attribute. Another follow query may be “why ceramic charcoal grill is expensive.” This language indicates that the user is interested in ceramic and pricing, which can be considered user preference attributes since the user asked about them in a question rather than a statement to show ceramic grills that are cheap, which might indicate required attributes. By analyzing the queries and contextual information, the AI system can accurately determine required attributes and user preference attributes of the user over the course of a user session and use this information to select relevant digital components that satisfy the hard c required attributes and preferably the user preference attributes as well.

In addition, the AI system can provide feedback to users to indicate whether attributes (e.g., required attributes and/or preferences) are satisfied by results (e.g., digital components) provided to the user. For example, the AI system can display a user interface that indicates, for an item that is the subject of a digital component, which attributes are satisfied by the item and which attributes are not satisfied by the item. In a particular example, if the AI system determines that a user is looking for leather boots and the digital component shows suede boots, the AI system can bold the term boots to highlight that attribute being satisfied and strikethrough the term suede to indicate that this is different from the leather attribute. Of course, other types of indicators can also be used. This feedback provides clues to the user as to which attributes are being used to select digital components so that the user can submit queries that refine the attributes, which can help the user to find the right information faster.

The techniques described in this document leverage artificial intelligence in a particular way to solve problems associated with determining a user's intent and/or informational needs and how they are adapted over a sequence of queries and provide to the user that the user is intending to find and/or that satisfies the user's informational needs. For example, the described techniques can include using multiple artificial intelligence models to identify the attributes and their importance, to select digital components related to the attributes, and to adjust the visual characteristics of text for attributes in the digital components, which combine to help a user find the intended content faster thereby providing the technical advantages described above and elsewhere herein.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which artificial intelligence is used to evaluate attributes of items and to distribute digital components to client devices.

FIG. 2 is a block diagram illustrating interactions between an artificial intelligence system, a language model, a digital component evaluation model, and a client device.

FIG. 3 is a flow chart of an example process of evaluating attributes of items during a user session and providing digital components based on the evaluation of the attributes.

FIG. 4 is a block diagram of an example computer.

Like reference numbers and designations in the various drawings indicate like elements.

### DETAILED DESCRIPTION

This specification describes techniques for enabling artificial intelligence to evaluate the importance of attributes of user queries and/or items that are the subject of the queries and use this information to provide relevant content based on the queries. Artificial intelligence (AI) is a segment of computer science that focuses on the creation of intelligent agents that can learn and act autonomously (e.g., with little or no human intervention). Artificial intelligence can utilize machine learning, which focuses on developing algorithms that can learn from data, natural language processing, which focuses on understanding and generating human language, and/or computer vision, which is a field that focuses on understanding and interpreting images and videos.

The techniques described throughout this document enable AI to determine the relative importance of attributes and use the attributes and their importance to select relevant content, e.g., digital components, for distribution to client devices of users. During a user session, a user can submit multiple queries to the AI system. The queries can be in the form of search queries for a search system or a prompt for a machine learning model (e.g., in a conversation with an AI agent). The AI system can identify attributes of an item based on the queries and determine the relative importance of the attributes based on the queries and optionally additional information. For example, the AI system can generate an input for a machine learning model based on one or more queries submitted by the user during a user session. The input can include text of the queries, timing data for the queries, contextual information (e.g., linguistic clues in the queries), and/or user interactions with search results and/or digital components presented to the user.

The machine learning model can be a language model that is trained to output attributes of items and importance data that indicates the relative importance of the attributes based on the input data. The importance data can include an importance value for each attribute, e.g., a numerical score or ranking. The importance data can be a classification of the attribute, e.g., as a required attribute or a user preference attribute. In this example, a required attribute can be an attribute that the machine learning model predicts to be required by the user in an item for which content is displayed. A user preference attribute can be an attribute that the machine learning model predicts that the user prefers but may be willing to accept a substitute attribute in place of that attribute. For example, if a user is searching for a silver minivan that seats seven people, minivan may be a required attribute of a vehicle (item) and silver may be a user preference attribute. The machine learning model can be trained to use the input data to identify attributes of an item and determine their relative importance.

During the course of a user session, the queries submitted by the user can provide additional information that enables the AI system to refine the set of attributes and their importance. The AI system can generate input data for the machine learning model based on multiple queries and information about the queries (e.g., relative timing data) to enable the machine learning model to evaluate the response of the user (e.g., in the form of subsequent queries) to content provided to the user in response to the queries. Using AI in this way enables the machine learning model to fine tune attribute importance over multiple iterations and to arrive at more accurate importance measures and more relevant content faster than other techniques.

The AI system can also select digital components based on the identified attributes and their importance. As described below, the AI system can select the digital components that have distribution parameters that match at least the required attributes identified by the AI system and provide the selected digital components to the client device of the user.

As used throughout this document, the phrase “digital component” refers to a discrete unit of digital content or digital information (e.g., a video clip, audio clip, multimedia clip, gaming content, image, text, bullet point, artificial intelligence output, language model output, or another unit of content). A digital component can electronically be stored in a physical memory device as a single file or in a collection of files, and digital components can take the form of video files, audio files, multimedia files, image files, or text files and include advertising information, such that an advertisement is a type of digital component.

The AI system can also provide feedback to users to indicate whether attributes (e.g., required attributes and/or preferences) are satisfied by results (e.g., digital components) provided to the user. For example, the AI system can display multiple digital components with attributes about items that are the subject of the digital component. For attributes of the item that is the subject of the digital component that satisfies (e.g., the item has attributes that match) attributes of the attributes identified by an AI model based on the user's queries, the AI system can highlight the attributes, e.g., by bolding the text for the attribute in the digital component or showing a box around the text. Similarly, the AI system can strikethrough text for attributes in the digital component for attributes of the item that do not satisfy the user's queries. Thus, the AI system can adjust visual characteristics of the text for an attribute based on whether the attribute of the item is a satisfied attribute.

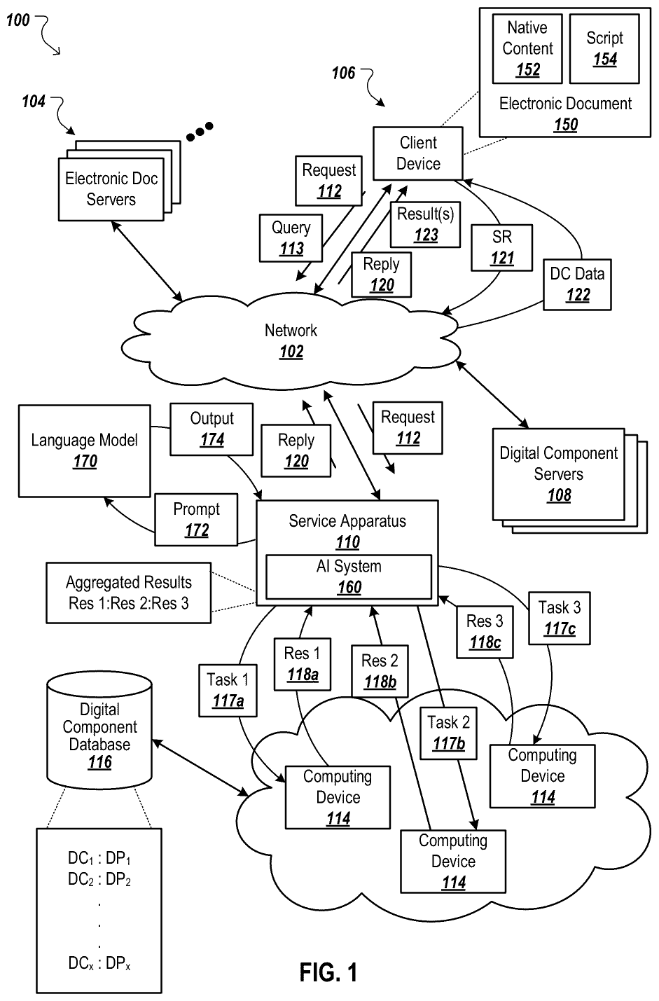

FIG. 1 is a block diagram of an example environment 100 in which artificial intelligence is used to evaluate attributes of items and to distribute digital components to client devices 106. The example environment 100 includes a network 102, such as a local area network (LAN), a wide area network (WAN), the Internet, or a combination thereof. The network 102 connects electronic document servers 104, user devices 106, digital component servers 108, and a service apparatus 110. The example environment 100 may include many different electronic document servers 104, client devices 106, and digital component servers 108.

The service apparatus 110 is configured to provide various services to client devices 106 and/or publishers of electronic documents 150. In some implementations, the service apparatus 110 can provide search services by providing responses to queries 113 received from client devices 106. For example, the services apparatus 110 can include a search engine and/or an AI agent that enables users to interact with the agent over the course of multiple conversational queries and responses. The service apparatus 110 can also distribute digital components to client devices 106 for presentation with the responses and/or with electronic documents 150. The service apparatus 110 is described in further detail below.

A client device 106 is an electronic device capable of requesting and receiving online resources over the network 102. Example client devices 106 include personal computers, gaming devices, mobile communication devices, digital assistant devices, augmented reality devices, virtual reality devices, and other devices that can send and receive data over the network 102. A client device 106 typically includes a user application, such as a web browser, to facilitate the sending and receiving of data over the network 102, but native applications (other than browsers) executed by the client device 106 can also facilitate the sending and receiving of data over the network 102.

A gaming device is a device that enables a user to engage in gaming applications, for example, in which the user has control over one or more characters, avatars, or other rendered content presented in the gaming application. A gaming device typically includes a computer processor, a memory device, and a controller interface (either physical or visually rendered) that enables user control over content rendered by the gaming application. The gaming device can store and execute the gaming application locally or execute a gaming application that is at least partly stored and/or served by a cloud server (e.g., online gaming applications). Similarly, the gaming device can interface with a gaming server that executes the gaming application and “streams” the gaming application to the gaming device. The gaming device may be a tablet device, mobile telecommunications device, a computer, or another device that performs other functions beyond executing the gaming application.

Digital assistant devices include devices that include a microphone and a speaker. Digital assistant devices are generally capable of receiving input by way of voice, and respond with content using audible feedback, and can present other audible information. In some situations, digital assistant devices also include a visual display or are in communication with a visual display (e.g., by way of a wireless or wired connection). Feedback or other information can also be provided visually when a visual display is present. In some situations, digital assistant devices can also control other devices, such as lights, locks, cameras, climate control devices, alarm systems, and other devices that are registered with the digital assistant device.

As illustrated, the client device 106 is presenting an electronic document 150. An electronic document is data that presents a set of content at a client device 106. Examples of electronic documents include webpages, word processing documents, portable document format (PDF) documents, images, videos, search results pages, and feed sources. Native applications (e.g., “apps” and/or gaming applications), such as applications installed on mobile, tablet, or desktop computing devices are also examples of electronic documents. Electronic documents can be provided to client devices 106 by electronic document servers 104 (“Electronic Doc Servers”).

For example, the electronic document servers 104 can include servers that host publisher websites. In this example, the client device 106 can initiate a request for a given publisher webpage, and the electronic server 104 that hosts the given publisher webpage can respond to the request by sending machine executable instructions that initiate presentation of the given webpage at the client device 106.

In another example, the electronic document servers 104 can include app servers from which client devices 106 can download apps. In this example, the client device 106 can download files required to install an app at the client device 106, and then execute the downloaded app locally (i.e., on the client device). Alternatively, or additionally, the client device 106 can initiate a request to execute the app, which is transmitted to a cloud server. In response to receiving the request, the cloud server can execute the application and stream a user interface of the application to the client device 106 so that the client device 106 does not have to execute the app itself. Rather, the client device 106 can present the user interface generated by the cloud server's execution of the app and communicate any user interactions with the user interface back to the cloud server for processing.

Electronic documents can include a variety of content. For example, an electronic document 150 can include native content 152 that is within the electronic document 150 itself and/or does not change over time. Electronic documents can also include dynamic content that may change over time or on a per-request basis. For example, a publisher of a given electronic document (e.g., electronic document 150) can maintain a data source that is used to populate portions of the electronic document. In this example, the given electronic document can include a script, such as the script 154, that causes the client device 106 to request content (e.g., a digital component) from the data source when the given electronic document is processed (e.g., rendered or executed) by a client device 106 (or a cloud server). The client device 106 (or cloud server) integrates the content (e.g., digital component) obtained from the data source into the given electronic document to create a composite electronic document including the content obtained from the data source.

In some situations, a given electronic document (e.g., electronic document 150) can include a digital component script (e.g., script 154) that references the service apparatus 110, or a particular service provided by the service apparatus 110. In these situations, the digital component script is executed by the client device 106 when the given electronic document is processed by the client device 106. Execution of the digital component script configures the client device 106 to generate a request for digital components 112 (referred to as a “component request”), which is transmitted over the network 102 to the service apparatus 110. For example, the digital component script can enable the client device 106 to generate a packetized data request including a header and payload data. The component request 112 can include event data specifying features such as a name (or network location) of a server from which the digital component is being requested, a name (or network location) of the requesting device (e.g., the client device 106), and/or information that the service apparatus 110 can use to select one or more digital components, or other content, provided in response to the request. The component request 112 is transmitted, by the client device 106, over the network 102 (e.g., a telecommunications network) to a server of the service apparatus 110.

The component request 112 can include event data specifying other event features, such as the electronic document being requested and characteristics of locations of the electronic document at which digital component can be presented. For example, event data specifying a reference (e.g., URL) to an electronic document (e.g., webpage) in which the digital component will be presented, available locations of the electronic documents that are available to present digital components, sizes of the available locations, and/or media types that are eligible for presentation in the locations can be provided to the service apparatus 110. Similarly, event data specifying keywords associated with the electronic document (“document keywords”) or entities (e.g., people, places, or things) that are referenced by the electronic document can also be included in the component request 112 (e.g., as payload data) and provided to the service apparatus 110 to facilitate identification of digital components that are eligible for presentation with the electronic document. The event data can also include a search query that was submitted from the client device 106 to obtain a search results page.

Component requests 112 can also include event data related to other information, such as information that a user of the client device has provided, geographic information indicating a state or region from which the component request was submitted, or other information that provides context for the environment in which the digital component will be displayed (e.g., a time of day of the component request, a day of the week of the component request, a type of device at which the digital component will be displayed, such as a mobile device or tablet device). Component requests 112 can be transmitted, for example, over a packetized network, and the component requests 112 themselves can be formatted as packetized data having a header and payload data. The header can specify a destination of the packet and the payload data can include any of the information discussed above.

The service apparatus 110 chooses digital components (e.g., third-party content, such as video files, audio files, images, text, gaming content, augmented reality content, and combinations thereof, which can all take the form of advertising content or non-advertising content) that will be presented with the given electronic document (e.g., at a location specified by the script 154) in response to receiving the component request 112 and/or using information included in the component request 112.

In some implementations, a digital component is selected in less than a second to avoid errors that could be caused by delayed selection of the digital component. For example, delays in providing digital components in response to a component request 112 can result in page load errors at the client device 106 or cause portions of the electronic document 150 to remain unpopulated even after other portions of the electronic document 150 are presented at the client device 106.

Also, as the delay in providing the digital component to the client device 106 increases, it is more likely that the electronic document will no longer be presented at the client device 106 when the digital component is delivered to the client device 106, thereby negatively impacting a user's experience with the electronic document. Further, delays in providing the digital component can result in a failed delivery of the digital component, for example, if the electronic document is no longer presented at the client device 106 when the digital component is provided. The techniques described in this document enable the fast selection of relevant digital components that prevent such errors and user frustration.

In some implementations, the service apparatus 110 is implemented in a distributed computing system that includes, for example, a server and a set of multiple computing devices 114 that are interconnected and identify and distribute digital component in response to requests 112. The set of multiple computing devices 114 operate together to identify a set of digital components that are eligible to be presented in the electronic document from among a corpus of millions of available digital components (DC₁₋ₓ). The millions of available digital components can be indexed, for example, in a digital component database 116. Each digital component index entry can reference the corresponding digital component and/or include distribution parameters (DP₁-DPₓ) that contribute to (e.g., trigger, condition, or limit) the distribution/transmission of the corresponding digital component. For example, the distribution parameters can contribute to (e.g., trigger) the transmission of a digital component by requiring that a component request include at least one criterion that matches (e.g., either exactly or with some pre-specified level of similarity) one of the distribution parameters of the digital component.

In some implementations, the distribution parameters for a particular digital component can include distribution keywords that must be matched (e.g., by electronic documents, document keywords, or terms specified in the component request 112) in order for the digital component to be eligible for presentation. Additionally, or alternatively, the distribution parameters can include embeddings that can use various different dimensions of data, such as website details and/or consumption details (e.g., page viewport, user scrolling speed, or other information about the consumption of data). The distribution parameters can also require that the component request 112 include information specifying a particular geographic region (e.g., country or state) and/or information specifying that the component request 112 originated at a particular type of client device (e.g., mobile device or tablet device) in order for the digital component to be eligible for presentation. The distribution parameters can also specify an eligibility value (e.g., ranking value, or some other specified value) that is used for evaluating the eligibility of the digital component for distribution/transmission (e.g., among other available digital components). As described in more detail below, the distribution parameters can include keywords that can be matched to attributes of items to determine the eligibility of the digital components.

The identification of the eligible digital component can be segmented into multiple tasks 117a-117c that are then assigned among computing devices within the set of multiple computing devices 114. For example, different computing devices in the set 114 can each analyze a different portion of the digital component database 116 to identify various digital components having distribution parameters that match information included in the component request 112. In some implementations, each given computing device in the set 114 can analyze a different data dimension (or set of dimensions) and pass (e.g., transmit) results (Res 1-Res 3) 118a-118c of the analysis back to the service apparatus 110. For example, the results 118a-118c provided by each of the computing devices in the set 114 may identify a subset of digital components that are eligible for distribution in response to the component request and/or a subset of the digital component that have certain distribution parameters. The identification of the subset of digital components can include, for example, comparing the event data to the distribution parameters, and identifying the subset of digital components having distribution parameters that match at least some features of the event data.

The service apparatus 110 aggregates the results 118a-118c received from the set of multiple computing devices 114 and uses information associated with the aggregated results to select one or more digital components that will be provided in response to the request 112. For example, the service apparatus 110 can select a set of winning digital components (one or more digital components) based on the outcome of one or more content evaluation processes, as discussed below. In turn, the service apparatus 110 can generate and transmit, over the network 102, reply data 120 (e.g., digital data representing a reply) that enable the client device 106 to integrate the set of winning digital components into the given electronic document, such that the set of winning digital components (e.g., winning third-party content) and the content of the electronic document are presented together at a display of the client device 106.

In some implementations, the client device 106 executes instructions included in the reply data 120, which configures and enables the client device 106 to obtain the set of winning digital components from one or more digital component servers 108. For example, the instructions in the reply data 120 can include a network location (e.g., a Uniform Resource Locator (URL)) and a script that causes the client device 106 to transmit a server request (SR) 121 to the digital component server 108 to obtain a given winning digital component from the digital component server 108. In response to the request, the digital component server 108 will identify the given winning digital component specified in the server request 121 (e.g., within a database storing multiple digital components) and transmit to the client device 106, digital component data (DC Data) 122 that presents the given winning digital component in the electronic document at the client device 106.

When the client device 106 receives the digital component data 122, the client device will render the digital component (e.g., third-party content), and present the digital component at a location specified by, or assigned to, the script 154. For example, the script 154 can create a walled garden environment, such as a frame, that is presented within, e.g., beside, the native content 152 of the electronic document 150. In some implementations, the digital component is overlayed over (or adjacent to) a portion of the native content 152 of the electronic document 150, and the service apparatus 110 can specify the presentation location within the electronic document 150 in the reply 120. For example, when the native content 152 includes video content, the service apparatus 110 can specify a location or object within the scene depicted in the video content over which the digital component is to be presented.

The service apparatus 110 also includes an AI system 160 configured to receive queries 113 and provide responses (e.g., in the form of results 123, such as search results, conversational results, and/or digital components) to the queries 113 using machine learning models. In some implementations, the AI system 160 can provide, to client devices 106, search interfaces that enables users to submit queries 113 in the form of prompts, questions, requests, or other types of natural language input. The search interfaces can be in the form of conversational user interfaces that show the dialog between the user and the AI system 160 during a user session. The AI system 160 can provide the queries 113 as inputs to a machine learning model, e.g., a language model 170, that generates responses to the queries 113. The AI system 160 can provide the responses to the client device 106 for presentation in the search interface. This enables the user to refine and evolve their expression of informational needs in an interactive manner. For example, after receiving a response to a query, the user can provide a subsequent query that refines the previous query or that adds context to the previous query. In a particular example, the user can provide a query, “what is the best resale value suv”. After getting results for a wide range of suvs, the user can provide a subsequent query, “I want a luxury suv” to refine the results to luxury suvs. The user can continue refining their expressions in subsequent queries 113 until obtaining the desired information.

The language model 170 can be a large language model (“LLM”), which is a model that is trained to generate and understand human language. LLMs are trained on massive datasets of text and code, and they can be used for a variety of tasks. For example, LLMs can be trained to translate text from one language to another; summarize text, such as web site content, search results, news articles, or research papers; answer questions about text, such as “What is the capital of Georgia?”; create chatbots that can have conversations with humans; and generate creative text, such as poems, stories, and code.

The language model 170 can be any appropriate language model neural network that receives an input sequence made up of text tokens selected from a vocabulary and auto-regressively generates an output sequence made up of text tokens from the vocabulary. For example, the language model 170 can be a Transformer-based language model neural network or a recurrent neural network-based language model.

In some situations, the language model 170 can be referred to as an auto-regressive neural network when the neural network used to implement the language model 170 auto-regressively generates an output sequence of tokens. More specifically, the auto-regressively generated output is created by generating each particular token in the output sequence conditioned on a current input sequence that includes any tokens that precede the particular text token in the output sequence, i.e., the tokens that have already been generated for any previous positions in the output sequence that precede the particular position of the particular token, and a context input that provides context for the output sequence.

For example, the current input sequence when generating a token at any given position in the output sequence can include the input sequence and the tokens at any preceding positions that precede the given position in the output sequence. As a particular example, the current input sequence can include the input sequence followed by the tokens at any preceding positions that precede the given position in the output sequence. Optionally, the input and the current output sequence can be separated by one or more predetermined tokens within the current input sequence.

More specifically, to generate a particular token at a particular position within an output sequence, the neural network of the language model 170 can process the current input sequence to generate a score distribution, e.g., a probability distribution, that assigns a respective score, e.g., a respective probability, to each token in the vocabulary of tokens. The neural network of the language model 170 can then select, as the particular token, a token from the vocabulary using the score distribution. For example, the neural network of the language model 170 can greedily select the highest-scoring token or can sample, e.g., using nucleus sampling or another sampling technique, a token from the distribution.

As a particular example, the language model 170 can be an auto-regressive Transformer-based neural network that includes (i) a plurality of attention blocks that each apply a self-attention operation and (ii) an output subnetwork that processes an output of the last attention block to generate the score distribution.

The language model 170 can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv:2203.15556, 2022; J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv:1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv:2005.14165, 2020.

Generally, however, the Transformer-based neural network includes a sequence of attention blocks, and, during the processing of a given input sequence, each attention block in the sequence receives a respective input hidden state for each input token in the given input sequence. The attention block then updates each of the hidden states at least in part by applying self-attention to generate a respective output hidden state for each of the input tokens. The input hidden states for the first attention block are embeddings of the input tokens in the input sequence and the input hidden states for each subsequent attention block are the output hidden states generated by the preceding attention block.

In this example, the output subnetwork processes the output hidden state generated by the last attention block in the sequence for the last input token in the input sequence to generate the score distribution.

Generally, because the language model is auto-regressive, the service apparatus 110 can use the same language model 170 to generate multiple different candidate output sequences in response to the same request, e.g., by using beam search decoding from score distributions generated by the language model 170, using a Sample-and-Rank decoding strategy, by using different random seeds for the pseudo-random number generator that's used in sampling for different runs through the language model 170 or using another decoding strategy that leverages the auto-regressive nature of the language model.

In some implementations, the language model 170 is pre-trained, i.e., trained on a language modeling task that does not require providing evidence in response to user questions, and the service apparatus 110 (e.g., using AI system 160) causes the language model 170 to generate output sequences according to the pre-determined syntax through natural language prompts in the input sequence.

For example, the service apparatus 110 (e.g., AI system 160), or a separate training system, pre-trains the language model 170 (e.g., the neural network) on a language modeling task, e.g., a task that requires predicting, given a current sequence of text tokens, the next token that follows the current sequence in the training data. As a particular example, the language model 170 can be pre-trained on a maximum-likelihood objective on a large dataset of text, e.g., text that is publicly available from the Internet or another text corpus.

In some implementations, the AI system 160 can generate a prompt 172 that is submitted to the language model 170 and causes the language model 170 to generate the output sequences 174, also referred to simply as “output”. The AI system 160 can generate the prompt in a manner (e.g., having a structure) that instructs the language model 170 to generate the output.

The AI system 160 can use the language model 170 to evaluate queries 113 to identify attributes of items that are, or at least predicted to be, items for which the user is searching for information and to determine the importance of the attributes. When a user searches for products or services, the user typically defines a set of attributes, which can be considered constraints on the items for which information or other content should be returned. Not every constraint, however, is equally important. Some attributes are required by the user, e.g., product or service category, attributes such as size or department, etc. These attributes can be referred to as required attributes, as described above. Some other attributes may be considered softer or negotiable. For example, when a user specifies a retailer or store (e.g., “shoes from retailer A”), the user may be open to other retailers. These attributes can be referred to as user preference attributes.

As noted above, a search interface provided by the AI system 160 allows users to refine and evolve their expression of information needs in an interactive way. The refinements and evolution of the queries over time in this dialog context provide valuable clues about the importance (e.g., the negotiability) of attributes. For example, although constraints about retail stores are typically negotiable, a user may specify in the search interface that they have a gift card for a specific retailer and that would make the retailer non-negotiable, and therefore a required attribute.

Users can refine their queries 113 throughout a user session with the search interface of the AI system 160. A user session can be defined by a start event and an end event. The start event can be the opening or launching of the search interface at the client device 106 or receipt of a first query from the client device 106. For example, the start event can be when the user navigates to a search interface provided in a web page or the opening of a native application that includes the search interface. The end event can be the closing of the search interface or a navigation from the web page that includes the search interface. The end event can also be based on a duration of time since a last query has been received. For example, the AI system 160 can determine that a user session has ended if no queries are received from the client device 106 for at least a threshold period of time, e.g., five minutes, ten minutes, one hour, or another time period.

The AI system 160 can update the set of attributes and their importance during the user session. For example, the AI system 160 can update the set of attributes and importance data that indicates the relative importance for each query 113 received during the user session. This enables the AI system 160 to leverage information of each query to better understand the user's informational needs and to assess which attributes are more important (e.g., non-negotiable) and which are less important (e.g., negotiable). The AI system 160 can use this information to provide responses in the search interface and/or to select and provide digital components for presentation with the responses, or in place of the responses, in the search interface.

As described above, the language model 170 can be trained using large datasets and/or on a language model task. In this example, the language model 170 can be trained on a task to determine attributes of an item based on one or more queries and the relative importance of the attributes. In some implementations, the language model 170 can be trained using few shot training. In this example, a pre-trained language model can be adapted to the task of determining the attributes and their relative importance.

In some implementations, the AI system 170 can train a language model 170 to output attributes of items and optionally their importance (e.g., as required attributes or user preference attributes) based on user queries and the same or different language model 170 to output an indication of whether attributes of an item satisfy (e.g., match) attributes identified based on the user queries. In some implementations, each language model 170 includes an LLM that is fine-tuned for these tasks. For example, each LLM can be fine-tuned using few-shot learning.

For the language model 170 that outputs indications of whether attributes of an item satisfy (e.g., match) attributes identified based on the user queries, an LLM can be fine-tuned using training samples (e.g., 20, 50, 100, 200, 300, 400, or another appropriate number) that include query that includes attributes and a title of an item (e.g., title of a product) that includes attributes of the item. The training samples can include (query, title) pairs where all prompts agreed and (query, title) pairs where all prompts disagreed. The LLM can be fine-tuned using both sets of (query, title) pairs. The LLM can be further fine-tuned by manually revising the data by fixing mistakes.

The language model 170 that outputs attributes and optionally their importance can be trained using a similar fine-tuning approach. In this example, the training samples can include (query sequence, attributes) pairs, e.g., (query sequence, attributes) pairs where the prompts agreed and (query sequence, attributes) pairs where the prompts disagreed.

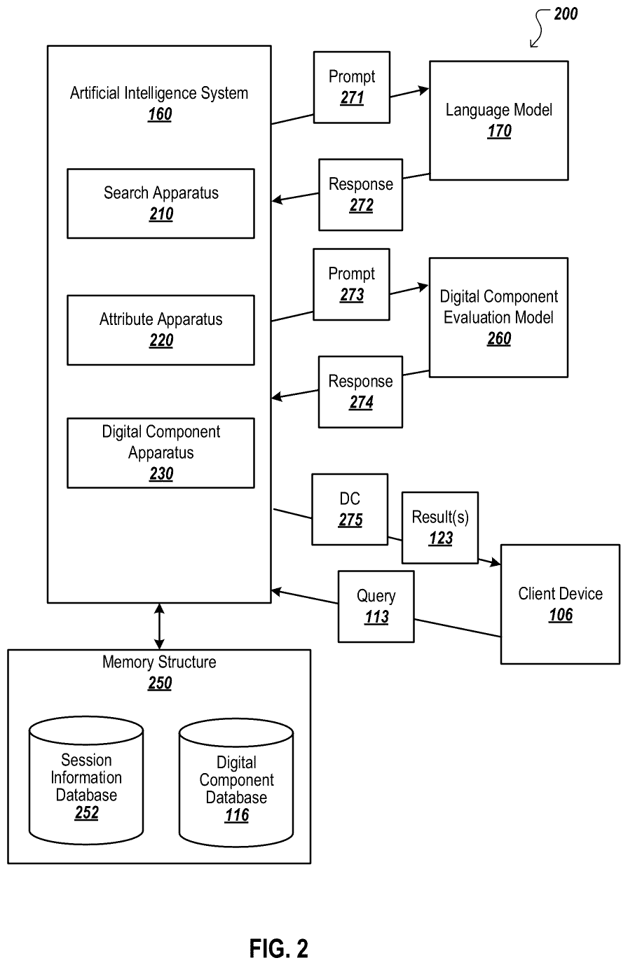

FIG. 2 is a block diagram illustrating interactions between an AI system 160, a language model 170, a digital component evaluation model 260, and a client device 106. In this example, the AI system 160 includes a search apparatus 210, an attribute apparatus 220, and a digital component apparatus 230. The various apparatus can interact with each other to provide content to client devices 106.

The AI system 160 also includes a memory structure 250 that includes a session information database 252 and the digital component database 116. The session information database 252 can store queries 113 received during a current user session, responses provided to the queries 113, information identifying digital components provided during the user session, and information indicating whether the user interacted with the digital components and, if so, the type of interaction (e.g., click, hover, conversion event, etc.). The session information database 252 can include the same or similar information for each of multiple users over multiple user sessions for that user.

The search apparatus 210 is configured to generate responses to queries 113 received from client devices 106 and provide results 123 that include the responses. The response can be in the form of an ordered list of search results and/or digital components (e.g., for presentation in a search results page) or a conversational response (e.g., for presentation in a conversation user interface). For example, a conversational response for a query for “what is the best resale value suv” can be “Here are some suvs with the best resale value: suv A, resale value 78%; suv B, resale value 72%; and suv C, resale value 65%”. A conversational response can have a natural language response, e.g., as compared to a search result with a defined structure having a snippet of text from an electronic document and link to the electronic document. In either user interface, the results can include search results and/or digital components, which can be in the form of sponsored search results.

In some implementations, the search apparatus 210 can use a language model 170 to generate a response to a query 113. For example, the search apparatus 210 can generate a prompt 271 that includes the query and/or instructions for identifying the response and provide the prompt 271 to the language model 170. The language model 170 can generate a response 272 and provide the response 272 to the search apparatus 210. The search apparatus 210 can send the result 123 that includes the response to the client device 106 for presentation to the user that submitted the query 113.

The user can generate and submit additional queries 113 that refine the expression of the user's informational needs. The search apparatus 210 can submit these queries 113 to the language model 170 in the form of prompts with instructions to refine the results of the previous query or queries based on the newly received query 113 and provide the response 272 from the language model 170 to the client device 106.

The attribute apparatus 220 is configured to identify attributes of items based on queries 113 received from client devices 106 and evaluate the importance of the attributes. The attribute apparatus 220 can update a list of attributes and their importance during a user session, e.g., in response to each query 113 received from the client device 106 during the user session. As described above, the importance of the attributes can be expressed as a value or score (e.g., 1-3, 1-10, 0-100, or another appropriate scale) or a classification (e.g., required attribute vs. user preference attribute or non-negotiable vs. negotiable).

In some implementations, the attribute apparatus 220 uses a language model 170 to identify the attributes and/or to determine the importance of the attributes. The language model 170 can be trained to identify attributes and their importance (e.g., as values and/or classifications) based on input data indicating one or more queries 113 and optionally information related to the queries, e.g., timing data that indicates the relative timing of the queries 113 received from the client device 106, e.g., during the user session. The language model 170 used to identify and evaluate the relative importance of attributes can be the same or different from the language model 170 used to generate results for the queries 113.

The attribute apparatus 220 can generate input data that includes the queries and/or information related to the queries. In some implementations, the input data is included in a prompt for the language model 170. For example, the prompt can include instructions that instruct the language model 170 to identify attributes of items based on the input data and to output importance data that indicates the relative importance of the attributes. The attribute apparatus 220 can modify a prompt or prompt template based on the input data and provide the modified prompt to the language model 170. The language model 170 can return a response 272 that includes the identified attributes and the importance data that indicates the importance of the attributes.

The following example is provided to illustrate how attributes and importance can be determined and updated by the attribute apparatus 220 during the course of a user session. A first query can be “how to find live music in San Francisco”. In this example, the attribute apparatus 220 can send a prompt 271 to the language model 170 and the language model can identify the attributes of “live”, “music”, and “San Francisco.” The importance data can indicate that San Francisco is more important than music and music is more important than live. For example, it appears that “San Francisco” and “music” are required or non-negotiable attributes that indicate the user is looking for music in a particular location, and live may be a user preference.

The search apparatus 210 can also evaluate the first query and provide results that identify venues that have live music of different varieties. The user can submit a second query to refine the results. For example, the second query may be “which one has rock”. The attribute apparatus 220 can submit a second prompt to the language model 170 that is based on the first query and the second query. The language model 170 can determine that “rock” is another attribute and update the set of attributes to “live”, “music”, “San Francisco,” and “rock”. Since rock was added in the second query as a refinement, it may be considered to have low importance or be a user preference rather than something that is very important or non-negotiable.

The search apparatus 210 can evaluate the second query along with information about the first query and/or responses to the first query to generate a response to the second query and provide the response to the client device 106. The response can include venues that have rock music.

The user can submit a third query to further refine the results. For example, the third query may be “are there any events there today”. The attribute apparatus 220 can submit a third prompt to the language model 170 that is based on the three queries that have been received. The language model 170 can determine that “today” is another attribute and update the set of attributes to “live”, “music”, “San Francisco,” “rock”, and “today”. Since today was added in the third query as a refinement and the linguistic clues indicate that the user is interested in events that occur today but may not require events today, it may be considered to have low importance or be a user preference rather than something that is very important or non-negotiable.

The search apparatus 210 can evaluate the third query along with information about the first two queries and/or responses to the first two queries to generate a response to the third query and provide the response to the client device 106. This response can include events that occur at the rock venue today.

The digital component apparatus 230 is configured to select one or more digital components to provide to client devices 106 in response to queries 113 and to provide the digital components to the client devices 106. The digital component apparatus 230 can be configured to select a digital component based on any of the information described above, e.g., event data included in a component request, and/or based on queries 113, the attributes identified based on the queries 113, and/or the importance of the attributes determined by the attribute apparatus 220.

In some implementations, the digital component apparatus 230 can compare attributes to the distribution parameters of digital components to a set of candidate digital components to identify a subset of the candidate digital components having distribution parameters that match one or more of the attributes. For example, a digital component can have, as a distribution parameter, the keywords “live” and “music”. This digital component may be identified as being eligible for distribution in response to example queries discussed above based on the keywords matching the attributes “live” and “music”. Another digital component with a keyword “rock” can become eligible after receipt of the query “which one has rock”. In some implementations, the keywords do not have to be an exact match for a digital component to be eligible. For example, the digital component with the keyword rock can be eligible based on it being a type of music and the attributes including “music”.

The digital component apparatus 230 can use the importance data that indicates the relative importance of the attributes to identify the eligible digital components and/or to select from among the eligible digital components. For example, the digital component apparatus 230 can identify, as eligible digital components, only those that have a distribution parameter that matches each required attribute (or non-negotiable attribute), or those having an importance value that satisfies a threshold (e.g., that meets or exceeds the threshold). In this example, the digital component apparatus 230 can filter, from the candidate digital components, each candidate digital component that does not have distribution parameters that match the required attributes or those that do not have an importance value that satisfies the threshold.

In another example, the digital component apparatus 230 can filter, from the candidate digital components, those having a distribution parameter that contradicts an attribute, contradicts a required attribute, or contradicts an attribute having an importance value that satisfies the threshold. A distribution parameter can contradict an attribute if the distribution parameter indicates that the digital component is not eligible for presentation if the attribute is identified or if a keyword of the distribution parameter is the opposite of or orthogonal to the attribute. In another example, a distribution parameter can contradict an attribute if the distribution parameter does not satisfy an attribute, e.g., a user-specified attribute, in a query. For example, if the query is for a “waterproof jacket” and a digital component includes content for a sweater made of cotton or wool, this will be a mismatch between the distribution parameter (e.g., cotton or wool sweater) and the attribute in the query (waterproof).

In another example, the digital component apparatus 230 can determine a ranking value for each digital component based on a level of match between the distribution parameters for the digital component and the attributes, the importance of the attributes, and optionally other factors, e.g., predicted or actual performance of the digital components and/or amounts that the provider of the digital component is willing to provide to a publisher for presentation of the digital component with an electronic document 150 of the publisher. In determining the overall value, the level of match between a distribution parameter and an attribute can be weighted based on the importance of the attribute. For example, a match between a required attribute and a keyword for a digital component can result in a higher overall value than a match between a user preference attribute and the keyword for the digital component. In another example, an attribute having a higher importance value that matches a keyword for a digital component can result in a higher ranking value than an attribute having a lower importance value that matches the keyword.

In some implementations, the digital component apparatus 230 uses a digital component evaluation model 260 to determine the ranking values for the digital components based on the attributes, their importance, and/or other data described above. The digital component evaluation model 260 can be a machine learning model, e.g., an LLM, that is trained to generate ranking values for digital components based on distribution parameters for the digital components, a set of attributes, importance data for the attributes, and/or other data that can be used to evaluate and determine values for digital components described herein. For example, the digital component evaluation model 260 can be trained to evaluate, for a candidate digital component, the level of match between the distribution parameters for the candidate digital component and the attributes and output a ranking value based on the level of match and the importance of each matching and non-matching attribute.

For example, the digital component evaluation model 260 can receive, as an input, data indicating one or more attributes of an item that is the subject of a digital component (or query terms of a received query) and the set of attributes output by the language model. Optionally, the digital component evaluation model 260 can also receive the importance data that indicates the relative importance of the attributes. The digital component evaluation model 260 can be trained to output data indicating which attributes of the item match the attributes output by the language model 170 (or query terms) and/or data indicating which attributes of the item do not match the attributes output by the language model 170 (or query terms).

In some implementations, the digital component evaluation model 260 can be implemented as a powerful teacher model that is pre-trained on training data and optionally updated using online learning techniques. To reduce the latency in evaluating digital components, the digital component apparatus 230 can use teacher distillation to train a distilled or student model that is easier to deploy and use at query time to determine the ranking values for a large number (e.g., hundreds, thousands, or more) of digital component, e.g., because the distilled model requires less computation, memory, or both. The distilled model can be trained and/or updated using indirect supervision. Additionally, to further reduce the latency in determining the ranking values, the digital component apparatus 230 can pre-compute token embeddings for the candidate digital components based on the distribution parameters for the candidate digital components. In this way, the digital component apparatus 230 can just generate the embeddings for the attributes and provide the embeddings as input to the digital component evaluation model 260 in response to receiving a query 113.

In either example, the digital component apparatus 230 can select zero or more digital components to provide to the client device 106 based on the ranking values. For example, the digital component apparatus 230 can provide a specified number of digital components having the highest ranking values. In another example, the digital component apparatus 230 can provide each digital component for which the ranking value satisfies a threshold, e.g., by meeting or exceeding the threshold. The client device 106 can present the digital component(s) received from the digital component apparatus 230.

In some implementations, the digital component apparatus 230 can also use a language model 170 (or another AI model) to determine whether attributes of an item that is the subject of a digital component satisfies attributes identified for a user based on the user's queries. For example, the input to this language model 170 can be a prompt that includes the two sets of attributes and instructions that instruct the language model 170 to output whether the attributes of the item satisfy (e.g., match) the attributes for the user's queries.

An attribute can satisfy another attribute if they two attributes match (e.g., are exactly the same or sufficiently similar) or if the attribute is a type of specifies or the other attribute. For example, the attribute of a coat may be the type of material. If the coat that is the subject of the digital component has the same material as the material specified by the user's queries, the material attributes can be said to match. In another example, the attribute may be materials of a coat but the attribute specified by the user's queries may be waterproof. In this example, any material coat that is waterproof would be determined to satisfy the waterproof attribute.

For attributes of an item that are considered satisfied, the digital component apparatus 230 can highlight those attributes in the digital component, e.g., by boldening the text for the attribute, showing the text in a different color or using underlining, showing a box around the text, or using other visual characteristics. If an attribute is considered to be non-satisfied (e.g., doesn't match), the digital component 230 can leave it as is or highlight it in a different way, e.g., striking through the text.

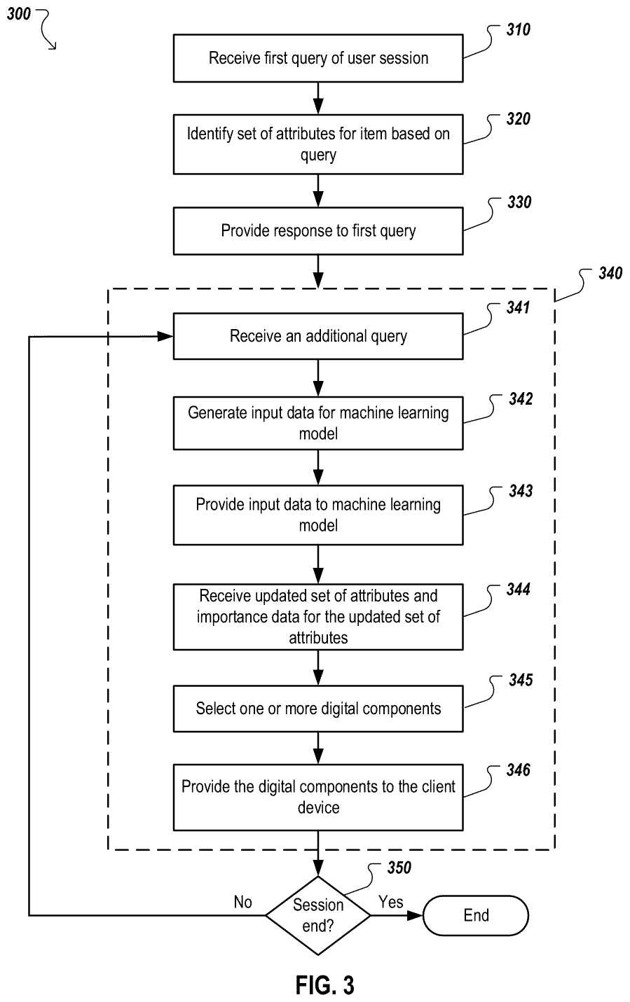

FIG. 3 is a flow chart of an example process 300 of evaluating attributes of items during a user session and providing digital components based on the evaluation of the attributes. The operations of the process 300 can be implemented by one or more computers, e.g., the AI system 160 of FIG. 1. The operations of the process 300 can also be implemented as instructions stored on a computer readable medium, which can be non-transitory. Execution of the instructions, by one or more data processing apparatus, causes the one or more data processing apparatus to perform operations of the process 300. For brevity, the process 300 is described as being performed by the AI system 160.

A first query is received during a user session (310). The service apparatus 110 can receive the first query from a client device 106. As described above, a user session with a search engine or AI agent can start when the user navigates to the web page or opens the application that provides the search services.

A set of attributes for an item are identified (320). As described above, the AI system 160 can use a language model 170 to identify the attributes of an item that is the subject of the first query, referenced by the first query, or predicted to be the subject of or referenced by the first query. For example, the AI system 160 can generate a prompt that includes at least a portion of the first query and instructions for the language model 170. The AI system 160 can provide the prompt to the language model 170 and receive, from the language model 170, a set of one or more attributes. The language model 170 can also output importance data that indicates the relative importance of each attribute, e.g., using classifications or importance values as described above. This is optional as the system can wait until multiple queries are received, in some implementations.

A response to the first query is provided to the client device 106 (330). The AI system 160 can use a language model to generate a response to the first query. In addition, the AI system 160 can select a digital component and provide the digital component to the client device 106 in response to the first query. As described above, the AI system 160 can select a digital component based on a query, identified attributes, the importance of the attributes, and/or other data, e.g., using a digital component evaluation model. The AI system 160 can provide the digital component for presentation with the response to the first query.

During the user session, the user can submit additional queries, e.g., to refine the expression of the user's informational needs based on the responses to each previous query. For each additional query or for at least one of the additional queries, the AI system 160 can update the attributes and their importance and provide responses and digital components (340). The AI system 160 can perform constituent operations 341-346 to provide the digital components.

An additional query is received (341). In response to receiving the additional query from the client device 106, the AI system 160 generates input data for a machine learning model (342). The AI system 160 can generate the input data based on the additional query and data related to one or more previous queries received during the user session. For the second query, the one or more previous queries would just be the first query. The input data can include each of the one or more previous queries or a portion of each query. The input data can also include timing data that indicates when each query was received (e.g., an order of the queries) during the user session and/or contextual information extracted from the one or more previous queries. As described above, the machine learning model can be a language model 170 that is trained to identify attributes and determine the relative importance of the attributes.

The input data is provided as an input to the machine learning model (343). The AI system 160 can provide the input data to the machine learning model and receive, from the machine learning model, an updated set of attributes and importance data for the updated set of attributes (344). As described above, the importance data for each attribute can be a classification of the attribute (e.g., required or user preference) or an importance value.

One or more digital components are selected based on the updated set of attributes and the importance data for the updated set of attributes (345). For example, the AI system 160 can provide the updated set of attributes, the importance data, distribution parameters for candidate digital components, and/or additional data such as one or more of the queries received during the user session to a machine learning model that is trained to output ranking values for the candidate digital components. The AI system 160 can select the one or more digital components based on the ranking values, e.g., by selecting the one or more digital components having the highest ranking values.

The one or more digital components are provided to the client device 106 for display to the user (346). For example, the AI system 160 can generate a response to the additional query and provide the response and the one or more digital components to the client device 106 for display to the user.

A determination is made whether the user session has ended (350). As described above, the user session can end if the user navigates from the web page or closes that application that provides the search services. If the user session has not ended, the process 300 can return to operation 341 at which an additional query can be received.

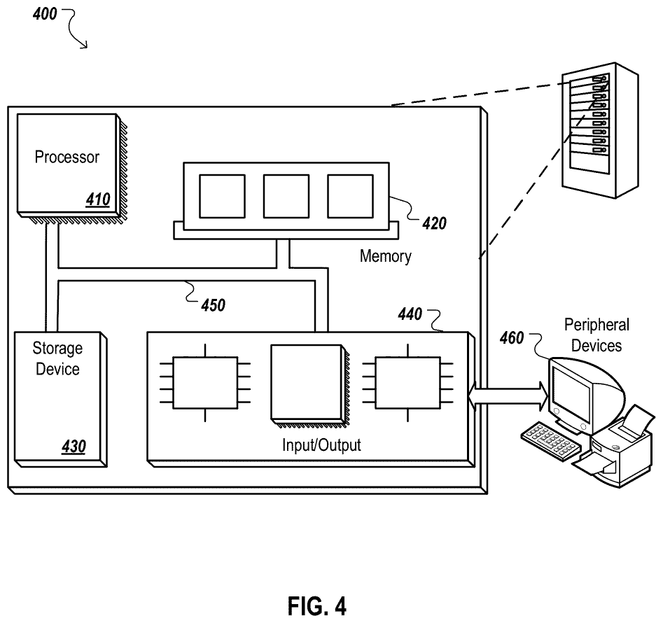

FIG. 4 is a block diagram of an example computer system 400 that can be used to perform operations described above. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, a storage device that is shared over a network by multiple computing devices (e.g., a cloud storage device), or some other large capacity storage device.

The input/output device 440 provides input/output operations for the system 400. In one implementation, the input/output device 440 can include one or more of a network interface devices, e.g., an Ethernet card, a serial communication device, e.g., and RS-232port, and/or a wireless interface device, e.g., and 802.11 card. In another implementation, the input/output device can include driver devices configured to receive input data and send output data to other devices, e.g., keyboard, printer, display, and other peripheral devices 460. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

For situations in which the systems discussed here collect and/or use personal information about users, the users may be provided with an opportunity to enable/disable or control programs or features that may collect and/or use personal information (e.g., information about a user's social network, social actions or activities, a user's preferences, or a user's current location). In addition, certain data may be treated in one or more ways before it is stored or used, so that personally identifiable information associated with the user is removed. For example, a user's identity may be anonymized so that no personally identifiable information can be determined for the user, or a user's geographic location may be generalized where location information is obtained (such as to a city, ZIP code, or state level), so that a particular location of a user cannot be determined.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

This document refers to a service apparatus. As used herein, a service apparatus is one or more data processing apparatus that perform operations to facilitate the distribution of content over a network. The service apparatus is depicted as a single block in block diagrams. However, while the service apparatus could be a single device or single set of devices, this disclosure contemplates that the service apparatus could also be a group of devices, or even multiple different systems that communicate in order to provide various content to client devices. For example, the service apparatus could encompass one or more of a search system, a video streaming service, an audio streaming service, an email service, a navigation service, an advertising service, a gaming service, or any other service.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method, comprising:
receiving, by an artificial intelligence system and from a client device of a user, a first query of a user session;
receiving, by the artificial intelligence system, one or more additional queries during the user session;
for each additional query:
generating, by the artificial intelligence system, input data based on (i) the additional query and (ii) data related to one or more previous queries received during the user session;
providing, by the artificial intelligence system, the input data as an input to a machine learning model trained to output attributes of items and importance data indicating a relative importance of the attributes based on received inputs;
receiving, by the artificial intelligence system, a set of attributes and importance data for the set of attributes as an output of the machine learning model;
selecting, by the artificial intelligence system and based on the set of attributes and the importance data for the set of attributes, one or more digital components; and
providing, by the artificial intelligence system, the digital component to the client device for display to the user.

2. The method of claim 1, wherein the user session comprises a conversation with an artificial intelligence agent and each query comprises a prompt for the artificial intelligence agent.

3. The method of claim 1, wherein the input data for at least one additional query comprises data from one or more previous sessions of the user.

4. The method of claim 1, wherein the importance data for each set of attributes indicates, for each individual attribute, whether the individual attribute is a required attribute or a user preference.

5. The method of claim 1, wherein selecting the one or more digital components comprises:
identifying a set of candidate digital components;
identifying, from among the set of candidate digital components, a subset of the candidate digital components having distribution parameters that match each required attribute; and
selecting the one or more digital components from the subset of the candidate digital components.

6. The method of claim 5, comprising filtering, from the set of candidate digital components, each candidate digital component having a distribution parameter that indicates that the candidate digital component is not eligible for presentation for component requests that include at least one required attribute in the importance data for the set of attributes.

7. The method of claim 1, wherein selecting the one or more digital components comprises:
providing the set of attributes, the importance data for the set of attributes, and distribution parameters to an additional machine learning model trained to output scores for digital components based on input data provided to the additional machine learning model; and
selecting the one or more digital components from a set of candidate digital components based on scores for the candidate digital components output by the additional machine learning model.

8. The method of claim 1, wherein the input data comprises, for each of the one or more previous queries, timing data indicating when the previous query was received during the user session.

9. The method of claim 1, wherein the input data comprises contextual information extracted from the one or more previous queries.

10. The method of claim 1, further comprising:
providing the set of attributes and an additional set of attributes for the digital component an input to an additional machine learning model trained to determine whether attributes for a digital component satisfy an input set of attributes;
receiving, from the additional machine learning model, data indicating one or more attributes for the digital component that satisfy at least one of the set of attributes; and
adjusting a visual characteristic of text for each of the one or more attributes in the digital component provided to the client device for display to the user.

11. A system comprising:
one or more processors; and
one or more storage devices storing instructions that, when executed by the one or more processors, cause the one or more processors to perform operations comprising:
receiving, from a client device of a user, a first query of a user session;
receiving one or more additional queries during the user session;
for each additional query:
generating input data based on (i) the additional query and (ii) data related to one or more previous queries received during the user session;
providing the input data as an input to a machine learning model trained to output attributes of items and importance data indicating a relative importance of the attributes based on received inputs;
receiving a set of attributes and importance data for the set of attributes as an output of the machine learning model;
selecting, based on the set of attributes and the importance data for the set of attributes, one or more digital components; and
providing the digital component to the client device for display to the user.

12. The system of claim 11, wherein the user session comprises a conversation with an artificial intelligence agent and each query comprises a prompt for the artificial intelligence agent.

13. The system of claim 11, wherein the input data for at least one additional query comprises data from one or more previous sessions of the user.

14. The system of claim 11, wherein the importance data for each set of attributes indicates, for each individual attribute, whether the individual attribute is a required attribute or a user preference.

15. The system of claim 11, wherein selecting the one or more digital components comprises:
identifying a set of candidate digital components;
identifying, from among the set of candidate digital components, a subset of the candidate digital components having distribution parameters that match each required attribute; and
selecting the one or more digital components from the subset of the candidate digital components.

16. The system of claim 15, wherein the operations comprise filtering, from the set of candidate digital components, each candidate digital component having a distribution parameter that indicates that the candidate digital component is not eligible for presentation for component requests that include at least one required attribute in the importance data for the set of attributes.

17. The system of claim 11, wherein selecting the one or more digital components comprises:
providing the set of attributes, the importance data for the set of attributes, and distribution parameters to an additional machine learning model trained to output scores for digital components based on input data provided to the additional machine learning model; and
selecting the one or more digital components from a set of candidate digital components based on scores for the candidate digital components output by the additional machine learning model.

18. The system of claim 11, wherein the input data comprises, for each of the one or more previous queries, timing data indicating when the previous query was received during the user session.

19. The system of claim 11, wherein the input data comprises contextual information extracted from the one or more previous queries.

20. A non-transitory computer readable storage medium carrying instructions that, when executed by one or more processors, cause the one or more processors to perform operations comprising:
receiving, by an artificial intelligence system and from a client device of a user, a first query of a user session;
receiving, by the artificial intelligence system, one or more additional queries during the user session;
for each additional query:
generating, by the artificial intelligence system, input data based on (i) the additional query and (ii) data related to one or more previous queries received during the user session;
providing, by the artificial intelligence system, the input data as an input to a machine learning model trained to output attributes of items and importance data indicating a relative importance of the attributes based on received inputs;
receiving, by the artificial intelligence system, a set of attributes and importance data for the set of attributes as an output of the machine learning model;
selecting, by the artificial intelligence system and based on the set of attributes and the importance data for the set of attributes, one or more digital components; and
providing, by the artificial intelligence system, the digital component to the client device for display to the user.
